(19) United States
(12) Patent Application Publication
(10) Pub. No.: US 2007/0099080 A1
(43) Pub. Date: May 3, 2007

(54) Thermal battery with reduced operational temperature

(76) Inventors: David Franklin Pickett JR., Colorado Springs, CO (US); Scott Brian Preston, Colorado Springs, CO (US); Ronald Armand Guidotti, Minden, NV (US); John Stuart Wilkes, Larkspur, CO (US)

Correspondence Address: Kenyon & Kenyon, 1500 K Street, NW, Washington, DC, 20005, US

(21) Appl. No.: 11/582,957

(22) Filed: Oct. 19, 2006

Related U.S. Application Data
(60) Provisional application No. 60/730,870, filed on Oct. 28, 2005.

(51) Int. Cl. H01M 6/16; H01M 4/40; H01M 4/46; H01M 4/50; H01M 4/48; H01M 4/52; H01M 4/56; H01M 6/36

(52) U.S. Cl. 429/188; 429/231.95; 429/231.6; 429/231.9; 429/221; 429/231.3; 429/223; 429/224; 429/219; 429/231.5; 429/225; 429/112

(57) ABSTRACT

An electrochemical cell for a medium-temperature thermal battery includes an electrolyte having a melting point between 75° C. and 200° C., a thermal decomposition temperature above 300° C., and consisting essentially of at least one organic salt. The electrolyte is ionically conductive at temperatures from the melting point to at least the thermal decomposition temperature, generating a voltage across a cathode and an anode of the cell. The electrolyte is ionically non-conductive at temperatures below the melting point.

### RELATED APPLICATIONS

This application claims the benefit of U.S. Provisional Application No. 60/730,870 filed Oct. 28, 2005, the contents of which are incorporated herein by reference.

### UNITED STATES GOVERNMENT RIGHTS

This invention was made with U.S. Government support under Contract No. FA8650-04-M-2427 awarded by the United States Air Force. The government has certain rights in this invention.

### FIELD OF THE INVENTION

The present invention generally relates to electrochemical cells for thermal batteries that generate a stable voltage across the 200° C. to 300° C. range.

### BACKGROUND

Thermal batteries are batteries that are inert at room temperature, but are activated if heated. The cells within a thermal battery typically remain electrically inert until actuated by melting an electrolyte. They have a long shelf-life at ordinary temperatures—typically 10 to 25 years. Once actuated, thermal batteries supply electric power for anywhere from a few seconds to over an hour. Thermal batteries commonly use the LiAl/FeS₂ or LiSi/FeS₂ anode-cathode couples with various molten salts as electrolytes. Electrolyte melting points of such batteries are typically between 313° and 436° C.

Heat for the electrolyte is typically provided by a pyrotechnic material. Two principal pyrotechnics for thermal batteries are heat pellets and heat paper, which typically are integrated with the individual cells within the battery. Heat pellets are pressed tablets consisting of a mixture of iron power and potassium perchlorate. Heat paper is a paper-like composition of zirconium and barium chromate powders supported in an inorganic fiber mat. After combustion, the remnants of heat pellets typically are electrically conductive, whereas the inorganic fiber mat (e.g., ceramic fibers; glass fibers) remnants of heat paper typically are electrically non-conductive. Another solution is a pyrotechnic heat “cylinder” wrapped around the periphery of the cells.

So long as the electrolyte remains molten, thermal batteries will discharge until the active materials are exhausted. Once actuated, the chemical processes of the battery itself may create heat that contributes to maintaining a melted electrolyte. Eventually, absent continuing application of energy from an external heat source, this internal heat is exhausted and the electrolyte re-solidifies.

### SUMMARY OF THE INVENTION

An electrochemical cell for a medium-temperature thermal battery includes an electrolyte having a melting point between 75° C. and 200° C., a thermal decomposition temperature above 300° C., and consisting essentially of at least one organic salt. The electrolyte is ionically conductive at temperatures from the melting point to at least the thermal decomposition temperature, generating a voltage across a cathode and an anode. The electrolyte is ionically non-conductive at temperatures below the melting point.

The organic salt or salts of the electrolyte preferably include at least one species of tetraalkylammonium cation. Examples of species of tetraalkylammonium cations include, among other things, tetramethylammonium cations and tetraethylammonium cations. A tetraalkylammonium cation species may itself contain more than one alkyl species, such as both an ethyl and a methyl. A tetraalkylammonium cation may be a dialkylpyrrolidium cation.

The electrolyte may be eutectic, composed of, among other things, a blend of two or more of organic salts, at least one of which is a tetraalkylammonium salt.

At least one of the tetraalkylammonium salts may include an imide-based anion. The imide-based anion may be, among other things, bis(trifluoromethylsulfonyl) imide, bis(perfluorinatedalkylsulfonyl) imide, or bis(trifluoromethyl)imide.

At least one of the tetraalkylammonium salts may include an anion selected from halides, alkylsulfonates, arylsulfonates, perfluorinatedalkylsulfonates, tetrafluoroborate, trifluoromethanesulfonate, dicyanamide, tris(trifluoromethylsulfonyl)methide, and bis(trifluoromethylsulfonyl)methane.

The electrolyte may also include, among other things, lithium trifluoromethane sulfonate, lithium bromide, and/or a lithium imide (e.g., lithium bis(trifluoromethylsulfonyl)imide), mixed with the tetraalkylammonium salt or salts.

Primary materials for the anode include, among other things, Li, Li(Al), Li (Si), Li(Mg), other lithium alloys, Mg, Mg alloys, Ca, Ca alloys, Na, Na alloys, K, or K alloys. Preferably, no exothermic chemical reactions occur between the electrolyte and the primary anode material for temperatures at least up to and including 300° C. The anode may also include a binder to immobilize the primary material when in a liquid state. The anode binder preferably comprises a transition metal.

Primary materials for the cathode include, among other things, FeS₂, CoS₂, CrO₂, LiCoO₂, NiS₂, MnO₂, LiMn₂O₄, Ag₂Cro₄, K₂Cr₂O₇, WO₃, PbCrO₄ and CaCrO₄.

The electrolyte may also comprise an electrolyte binder to immobilize the organic salt or salts when molten. The electrolyte binder is preferably an oxide, nitride, or oxynitride.

### BRIEF DESCRIPTION OF THE DRAWINGS

FIG. 1 is an example of a thermal electrochemical cell, and is not drawn to scale.

FIG. 2 is a thermogravimetric analysis of tetramethylammonium bis(trifluoromethylsulfonyl)imide heated under Ar at 10° C./min.

FIG. 3 shows the results of differential scanning calorimetry tests for tetramethylammonium bis(trifluoromethylsulfonyl)imide.

FIG. 4 shows the results of differential scanning calorimetry tests for tetramethylammonium bis(trifluoromethylsulfonyl)imide heated with a Li(Al) alloy anode under Ar at 10° C./min.

FIG. 5 shows the results of differential scanning calorimetry tests for tetramethylammonium bis(trifluoromethylsulfonyl)imide heated with a Li(Si) alloy anode under Ar at 10° C./min.

FIG. 6 shows the discharge traces of thermal electrochemical cells in which the separator mix was made by blending 35% MgO with tetramethylammonium bis(trifluoromethylsulfonyl)imide salt, using a Li(Si) anode and a FeS₂ cathode, with a current density of 4.1 mA/cm².

FIG. 7 illustrates the effect of current density on the performance of thermal electrochemical cells in which the separator mix was made by blending 35% MgO with tetramethylammonium bis(trifluoromethylsulfonyl)imide salt, using a Li(Si) anode and a FeS₂ cathode, at a temperature of 200° C.

FIG. 8 shows the results of differential scanning calorimetry tests for tetraethylammonium bis(trifluoromethylsulfonyl)imide.

FIG. 9 shows the results of a cyclic differential scanning calorimetry test for tetraethylammonium bis(trifluoromethylsulfonyl)imide.

FIG. 10 is a thermogravimetric analysis of tetraethylammonium bis(trifluoromethylsulfonyl)imide heated under nitrogen at 10° C./min.

FIG. 11 shows the results of differential scanning calorimetry tests for tetramethylammonium bis(trifluoromethylsulfonyl)imide alone and mixed with lithium trifluoromethane sulfonate.

FIG. 12 shows the results of differential scanning calorimetry tests for tetramethylammonium bis(trifluoromethylsulfonyl)imide alone and mixed with lithium bis(trifluoromethylsulfonyl)imide.

FIG. 13 shows the results of differential scanning calorimetry tests for tetramethylammonium bis(trifluoromethylsulfonyl)imide alone and mixed with lithium bromide.

### DETAILED DESCRIPTION

There is a need for suitable lower-melting electrolytes to make a thermal battery operational at lower temperatures.

Many applications today in which the long-shelf life of a thermal battery would be highly desirable instead use conventional batteries. For example, conventional batteries are often used to power instrumentation while drilling geothermal and oil/gas boreholes. Since the ambient temperature of a borehole is 100° C. to around 400° C., both the conventional battery and the instrumentation are thermally protected by encapsulation in a dewar. Each time the battery needs to be replaced, the dewar must be opened, which is cumbersome and time consuming, increases the physical bulk of the apparatus, and requires a more expensive dewar. Existing thermal batteries (with melting temperatures 313° and 436° C.) can be used outside of a dewar, but require pyrotechnics for actuation. A thermal battery that could take advantage of the ambient heat of the borehole for actuation, without the need for pyrotechnics, would lower operation costs, simplify operation, and increase design flexibility.

Another desirable operating temperature range is across 200° C. and 300° C. for operation near high temperature electronics. Such electronics are increasingly used in applications such as guided ordinance systems. High-melting temperature thermal batteries can be used, but require copious amounts of thermal insulation to protect the electronics. If the operating temperature of the thermal battery was within the tolerances of the electronics, the form factor and mass of the apparatus could be reduced. Likewise, since the operating temperature would be lower than that of traditional thermal batteries, the quantity of pyrotechnic material could be reduced, and/or the reaction rate and temperature produced by the pyrotechnic can be lowered.

Previous research to develop a battery operable in these temperature ranges had not produced a stable cell. Electrolytes with CsBr are usable only above 250° C. Iodide-based eutectics have melting points as low as 158° C., but are highly sensitive to oxidation of the iodide by oxygen. Nitrate-based eutectics have melting points as low as 90°-124.5° C., but are dependent upon a passivation layer to prevent reaction of Li-alloy anodes with nitrate, have high self-discharge, and have a tendency for exothermic reactions at temperatures above 250° C. Ionic liquids (room temperature molten salts) show promise since some are stable to over 300° C.; however, they do not have the added stand-life protection of being in a non-conductive state while in storage. Work with imidazolium-based salts showed compatibility problems with conventional thermal-battery anodes (e.g., LiSi, LiAl, and Ca) at temperatures over 150° C.

Efforts were undertaken to build on the imidazolium-based salt work by introducing lithium bis(oxalate)borate to pacify the anode compatibility problems. Unfortunately, this introduced new problems; among other things, the lithium bis(oxalate)borate became thermally unstable near 280° C.

New electrolyte materials are disclosed herein that generate a reasonably flat voltage plateau and are stable across at least 200° C. to 300° C. The new electrolytes have melting points between 75° C. and 200° C. and a thermal decomposition temperature above 300° C. The electrolytes are ionically non-conductive at temperatures below the melting point, and are ionically conductive at temperature at temperatures from the melting point to at least the thermal decomposition temperature. When in the ionically conductive state, a voltage is generated. The electrolytes consist essentially of at least one organic salt.

As used herein, a salt is “organic” if it includes at least one carbon-hydrogen bond. The “melting point” of the electrolyte is the temperature at which (if sustained) the organic salts in the electrolyte assume a phase-pure liquid state. The “thermal decomposition temperature” of the electrolyte is the temperature at which the weight percent of the organic salts decreases by more than 2%, on a first heating of the electrolyte after formation, if measured at a rate of 10° C./minute by thermogravimetric analysis (TGA). The organic salts thermally decompose into simpler compounds as covalent bonds are irreversibly broken, reducing the weight percent of the organic salt present.

The organic salts described below in pure form (non-eutectic) have melting points in a range of approximately 100° C. to 200° C. Based on past experience with such organic salts, the melting temperature can be lowered by as much as 25° C. (if not more) by blending two or more of the organic salts to form a eutectic. With eutectic salts, the melting point of the blend is lower than the melting point of any of the component salts in pure form. For example, tetraethylammonium bis(trifluoromethylsulfonyl)imide has a melting temperature of approximately 105° C., while tetramethylammonium bis(trifluoromethylsulfonyl)imide has a melting temperature of approximately 135° C.; it is believed that by mixing these two salts, the melting point can be lowered below the melting point of either material (e.g., lowered below at least 100° C.), with the melting point depending upon the molar ratios of the respective salts. The exact molar ratio of materials to blend to achieve a particular melting temperature is easily determined by routine melting point-composition analysis. See, e.g., Royston M. Roberts et al, Chapter 3.2—Physical Constants: Melting Points, “Modern Experimental Organic Chemistry,” CBS College Publishing, pp. 78-89 (1985).

Since the new electrolytes are electrically and chemically inert at temperatures below the melting point, the storage life of the electrolytes is expected to be excellent and comparable to the electrolytes used in conventional thermal batteries.

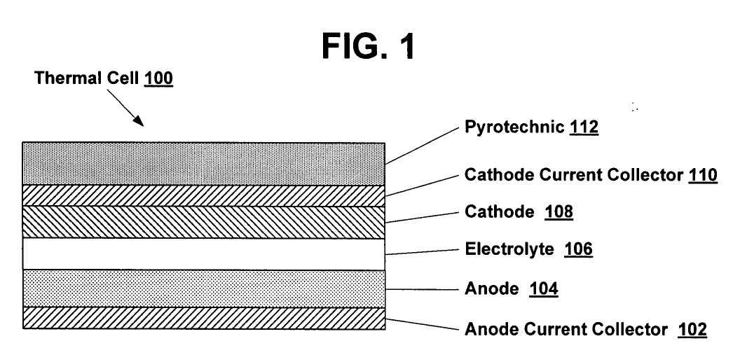

Thermal batteries comprise one or more electrochemical cells. FIG. 1 illustrates a generalized overview of an electrochemical cell which is used to demonstrate the present invention. The cell 100 comprises an anode current collector 102, an anode 104, an electrolyte 106, a cathode 108, a cathode current collector 110, and a pyrotechnic element 112.

The electrolyte 106 consists essentially of one or more organic salts. The organic salts preferably have a tetraalkylammonium cation. Examples of tetraalkylammonium cations include tetramethylammonium and tetraethylammonium cations. The tetraalkylammonium cation may be arranged as a dialkylpyrrolidium cation, such as diethylpyrrolidium or dimethylpyrrolidium. The tetraalkylammonium cation may also include more than one alkyl species within a same cation, such as a cation that includes both ethyl and methyl.

Each tetraalkylammonium salt in the electrolyte 106 also includes an anion. Examples of suitable anions include imide-based anions, halides, alkylsulfonates, arylsulfonates, perfluorinatedalkylsulfonates, tetrafluoroborate, trifluoromethanesulfonate, dicyanamide, tris(trifluoromethylsulfonyl)methide, and bis(trifluoromethylsulfonyl)methane. Imides comprise two acyl groups attached to a nitrogen, and may include a heterocyclic ring. Examples of imide-based anions include bis(trifluoromethylsulfonyl)imide, bis(perfluorinatedalkylsulfonyl)imide, and bis(trifluoromethyl)imide.

As described above, the electrolyte 106 may be eutectic. A eutectic may be formed by mixing a plurality of different tetraalkylammonium salts, such as: by mixing tetramethylammonium cations with tetraethylammonium cations; by mixing a plurality of the different anions; or by mixing both a plurality of the different cations and a plurality of the different anions.

Other compatible salts may also be used with organic salts having tetraalkylammonium cations (e.g., tetraalkylammonium imide salts) to lower the melting point, such as lithium trifluoromethane sulfonate, lithium bromide, or a lithium imide (e.g., lithium bis(trifluoromethylsulfonyl)imide).

Since the viscosity of molten organic salt electrolyte may be low at thermal battery operating temperatures, the cell 100 may include electrolyte containment. For example, the electrolyte 106 may be impregnated into a “separator,” such as an electrically nonconductive mesh, fabric, or tape (e.g., fiberglass, spun glass, cloth), a porous ceramic membrane (e.g., Whatman GF/C), or a paper. A chemically inert (at cell operating temperatures) binder may be added to the organic salts during compounding to immobilize the molten electrolyte. Oxides such as MgO, CaO, TiO₂, SiO₂, ZrO₂, Al₂O₃, and aluminosilicates; nitrides such as BN and AlN; and oxynitrides such as AlOₓN_{y}, are examples of preferred chemically inert binders. The binder may be a fused or sintered during compounding with the organic salt to form a separator. A particular advantage of nitride binders is good thermal conductivity, accelerating turn-on. The cell 100 may also include structures such as gaskets and cups.

Example structures for each of the anode 104 and the cathode 108 include a layer of metal or metal alloy, multiple layers, a pellet (e.g., compressed powder or blend of powders), a foil (for the anode), a composite structure, and/or an impregnated mesh (e.g., a fiber matrix).

The anode 104 needs to function at the operating temperatures of the electrochemical cell 100 without any significant loss of performance. Suitable materials for the anode 104 include Li, Li(Al), Li (Si), Li(Mg), other lithium alloys, Mg, Mg alloys, Ca, Ca alloys, Na, Na alloys, K, and K alloys. At operating temperatures, an anode material such as lithium is liquid. To immobilize the anode material, the cell 100 may also include a binder to hold the anode material in place. Preferably, the anode binder is made of a transition metal such as iron or nickel. The binder may be, for example, a powdered transition metal which is compounded with the anode material, or a sintered metal felt (e.g., Fe, Ni, or stainless steel Feltmetal®) that holds the anode material in place by surface tension.

A recurring problem in earlier research was exothermic reactions between the anode and the molten electrolyte, disrupting cell operation. Using the anodes 104 and electrolytes 106 described above, the exothermic reaction has been eliminated for temperatures at least up to and including 300° C.

Suitable materials for the cathode 108 include FeS₂, CoS₂, CrO₂, LiCoO₂, NiS₂, MnO₂, LiMn₂O₄, Ag₂CrO₄, K₂Cr₂O₇, WO₃, PbCrO₄ and CaCrO₄.

The anode current collector 102 may be formed from whatever material is convenient for wiring (e.g., Fe, Al, stainless steel). The cathode current collector 110 serves a similar function to the anode current collector. Materials for the cathode current collector 110 include stainless steel and graphite paper (e.g., Grafoil®). If a pyrotechnic 112 is placed proximate to the anode and/or cathode, the respective current collector 102, 110 may be used to prevent a chemical reaction between the pyrotechnic 112 and the anode/cathode, and to buffer the heat input to the cell 100.

Within a battery, plural cells 100 may be connected either in series (anode-to-cathode) or parallel (anode-to-anode, cathode-to-cathode), with or without intervening current collectors 102, 110. If no external connection is required between cells in the stack (e.g., series), a current collector may be used without external connection. Depending upon the placement of the cell in the battery, the construction of the anode 104 and cathode 108, and wiring needs, one or both current collectors may be omitted from an individual cell; for example, two adjacent cells in a stack may share a current collector.

Depending upon the particular cell architecture and the chemistry of the pyrotechnic 112 (e.g., heat pellets or heat paper), the position of the pyrotechnic 112 may be different. For example, the pyrotechnic 112 may be on the anode side of the cell, or may be in the form of~a heat “cylinder” wrapper around the periphery of the cell. If the electrochemical cell is designed to operate in high temperature ambients, the heat pyrotechnic 112 may be omitted.

The cathode 108 may contain electrolyte and/or separator material to impart ionic conductivity. The use of lithium oxide in the cathode as a lithiation and wetting agent improves the electrochemical performance of the cell. With coarse cathode materials (e.g., pyrite), the use of a separator in the cathode is preferred. For finely divided cathode materials (e.g., Ag₂CrO₄), pure electrolyte in the cathode is preferred. To improve pelletization and electrochemical performance, the catholyte mixture used for pressing of cathodes may be fused under an inert gas (e.g., Ar) for several hours at temperatures above the melting point but below the decomposition temperature.

Likewise, the anode 104 may contain electrolyte material. The addition of electrolyte to powdered anode materials (e.g., LiSi) greatly aids in pelletization, greatly reducing the pressure needed. It also provides an ionic pathway during discharge which greatly improves the electrochemical performance. The amount of electrolyte needed to achieve these goals will vary depending on the particle size and composition of the powdered anode material, but typically will range between 10 and 25 weight percent.

Thermal cell 100 provides a basic overview of cell design for the purpose of demonstration. In practice, cell 100 can be constructed in accordance with any design. For example, as known in the art, three common designs for thermal battery electrochemical cells are cup cells, open cells, and pelletized cells. Depending upon design requirements, cells commonly incorporate aspects of more than one design. For a detailed description of classic cell designs, see Chapter 21 (pp. 21.1-21.22) of the “Handbook of Batteries,” 3^{rd} edition, by David Linden and Thomas B. Reddy (editors), published by McGraw-Hill, New York, 2002.

While classic cells have rigid structures, other cell designs are also possible. For example, thermal cell 100 may be made flexible by using foil or graphite paper for current collectors 102 and 110; foil for anode 104 or an anode-impregnated mesh or sintered-metal felt; an electrolyte 106 impregnated into an electrically non-conductive mesh, fabric, tape, or paper; foil for cathode 108 or a cathode-impregnated mesh; and heat paper for pyrotechnic 112.

Depending upon the application, the thermal cell 100 may be run at temperatures above the decomposition temperature. As the organic salts begin to decompose, cell performance irreversibly declines. However, for some applications, such as those that require battery operation for only seconds, a balance can be struck between the decomposition rate, cell performance, and the operational life.

Experimental Results

Experiments with tetraalkylammonium salts show these materials to be particularly well suited to stably serve as the electrolyte 106. The results of characterization tests involving thermal stabilities and chemical compatibilities of tetraalkylammonium electrolytes with typical anode materials, and results of preliminary single-cell test data are presented below. Experiments were performed on each of anode/electrolyte/cathode combination using the same basic cell architecture.

For a first set of tests, tetramethylammonium bis(trifluoromethylsulfonyl)imide salt ((CH₃)₄N(CF₃SO₂)₂N) (“TMAIm”) was prepared as follows. A solution of 73.2 g tetramethylammonium chloride in 1100 mL water was added to a solution of 191.7 g of lithium bis(trifluoromethylsulfonyl)imide in 1000 mL of water with stirring followed by addition of 300 mL of water. The mixture was stirred for 0.75 h, cooled to 5° C. and filtered. The precipitate was washed 7 times with 250 mL of cold water. The product was air dried by pulling air though the material while still in the filter for about an hour and then dried 6 hours at 150° C. under vacuum to give 192 g (81% isolated yield; equals actual yield divided by theoretical yield) of tetramethylammonium bis(trifluoromethylsulfonyl)imide, having a melting point of 135-136° C.

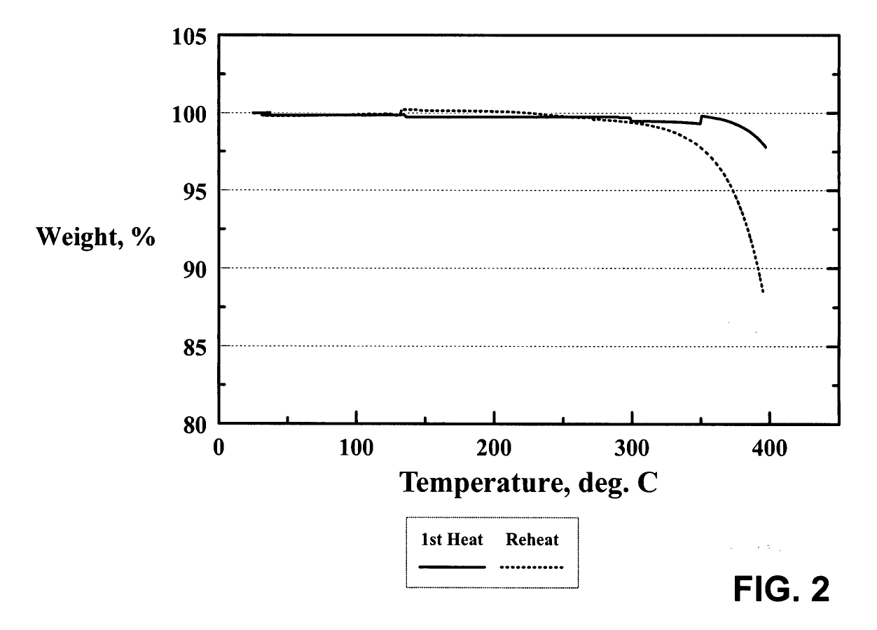

The thermal stability of TMAIm alone was tested as follows. TMAIm was dried an additional 6 h under vacuum prior to analysis. FIG. 2 summarizes the results of thermogravimetric analysis (TGA). As illustrated in the TGA results, the salt is thermally stable to about 350° C., with a decomposition temperature of about 375° C. on the first run. Decomposition is evident on the reheat where thermal decomposition occurred near 320° C.

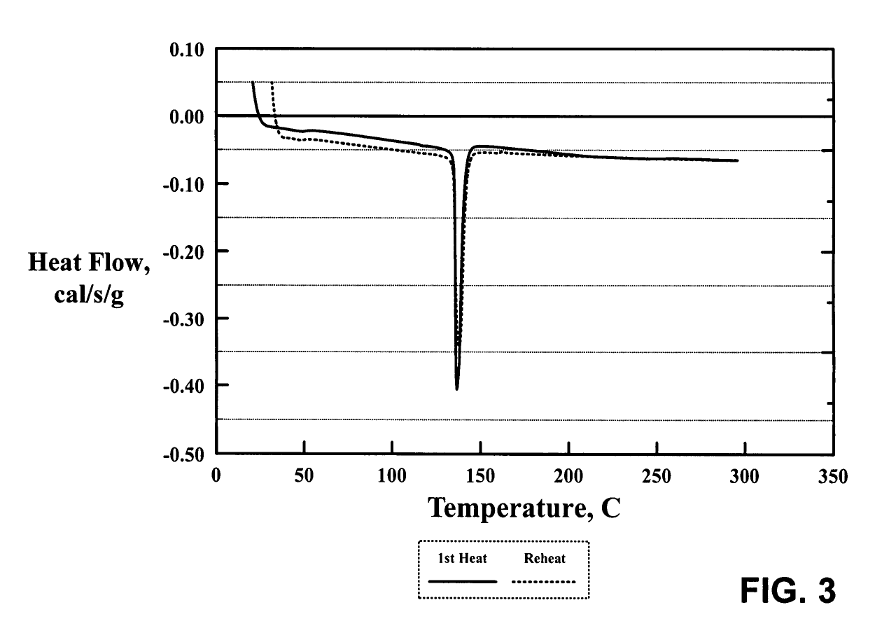

FIG. 3 summarizes the results of differential scanning calorimetry (DSC) tests. The TMAIm showed a sharp, single endotherm starting near 135° C., indicative of phase-pure material (i.e., a phase change from solid to liquid). Identical results were observed on the reheat.

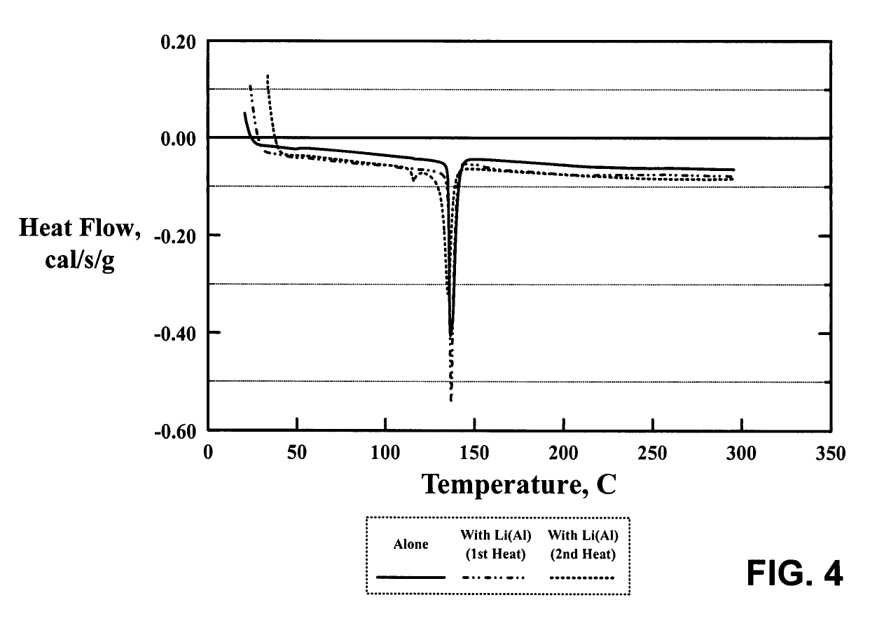

FIG. 4 summarizes thermal stability tests of TMAIm with an anode material. The DSC traces of TMAIm with a Li(Al) anode shows no sign of any exothermic reaction with the Li(Al), which had been a recurrent problem in earlier research. A slight endothermic peak was evident during the second heating, but still no evidence for an exotherm. The TMAIm showed complete compatibility with this highly reducing anode material at temperatures to 300° C. (which was the limit tested).

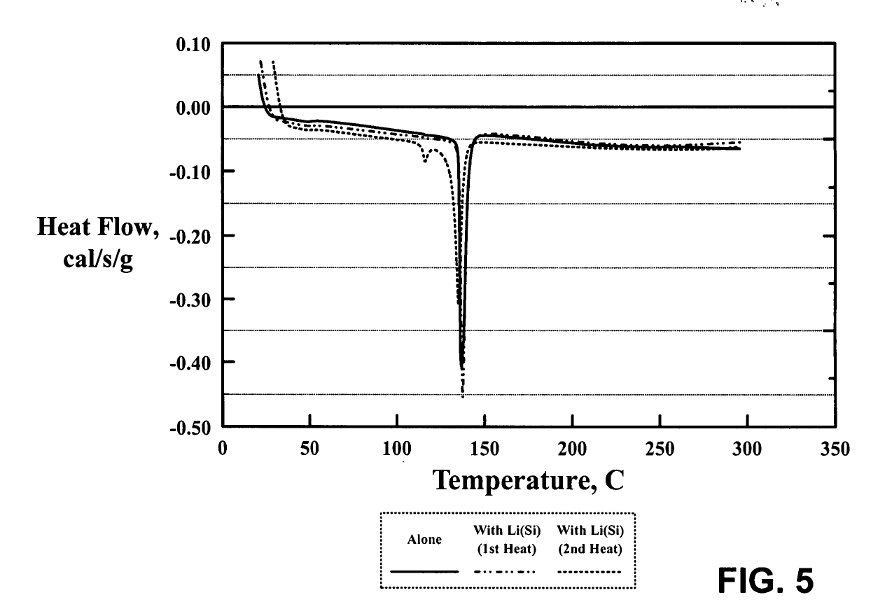

FIG. 5 summarizes the DSC traces for TMAIm with a Li(Si) anode. Similar behavior was observed with the Li(Si) alloy as for the Li(Al) alloy. This is especially important, since the Li(Si) has typically been shown to be more reactive than Li(Al) under such conditions. These additional data demonstrate this stability of TMAIm in a highly reducing environment.

Experimental cells were prepared with TMAIm as the electrolyte using conventional procedures for thermal battery cell construction. All preparation procedures were conducted in a glove box under Ar atmosphere. Percentages are by mass. The separator mix was made by blending 35% MgO with 65% TMAIm salt and fusing in the glove box at 200° C. for four hours. After granulation, it was pressed into separator pellets that weighted 0.25 g. The cathode pellet contained 73.5% FeS₂ (−325 mesh), 25% separator, and 1.5% Li₂O as a lithiation agent and weighed 0.275 g. The anode pellet contained 44% Li/56% Si alloy (−100+200 mesh) and 15% electrolyte and weighed 0.18 g. The die for pressing the pellets was 16.0 mm (0.6305 in.) in diameter with a center hole of 5.0 mm (0.197 in.), for an area of 1.818 cm².

The cells were assembled and stapled between two mica sheets to electrically insulate them and to hold the parts together. The cells were then heated between platens at desired experimental temperatures and current densities. Tests were conducted at 150°, 200°, and 250° C. at a current density of 4.1 mA/cm² (7.5 mA); one test was also run at 200° C. at twice this current density.

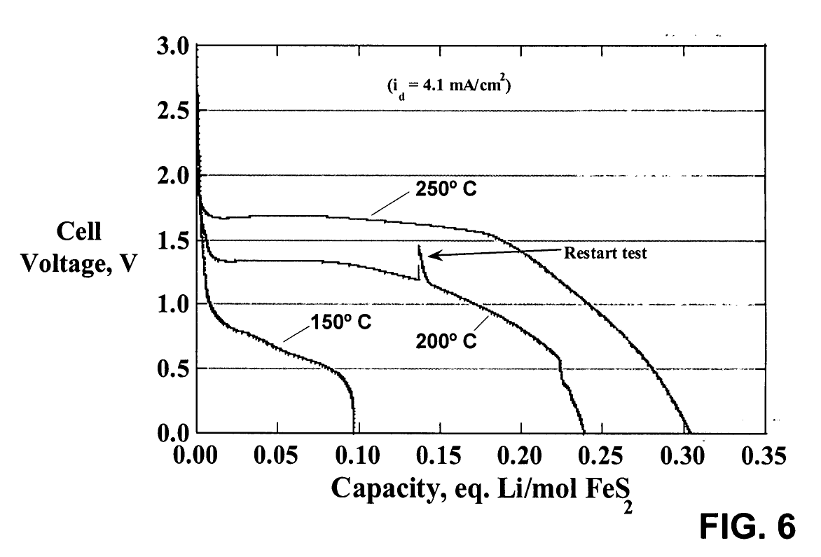

FIG. 6 summarizes the effect of temperature on cell performance. As expected, the performance improved as the temperature was increased. The relatively poor performance at 150° C. is due to the cell being only 15° C. above the melting point, which leads to strong Li+ concentration gradients and the accompanying sharp rise in impedance (resistance polarization). (This is typical for electrolytes used in thermal batteries with Li-alloy anodes.)

The voltage plateau with TMAIm and the Li(Si)/FeS₂ couple is reasonably flat-which is important for most thermal-battery applications-but higher capacities would be desired. It is felt that by optimization of materials processing and compositions, improvements in the electrochemical performance can be realized.

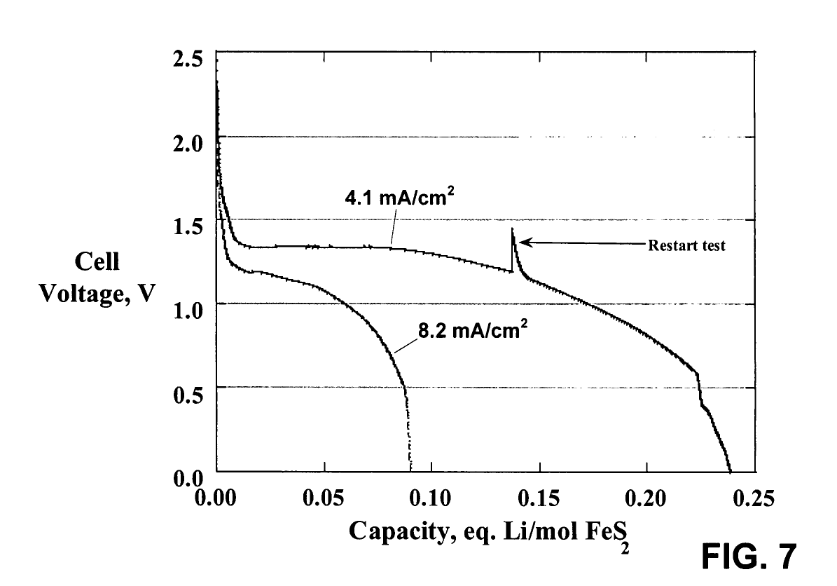

FIG. 7 summarizes the results of tests at 200° C. for two current densities. “Restart test” was a test time out, after which the test had to be restarted. The capacity dropped by a little more than half when the current density was doubled. Again, this is what one would expect under these discharge conditions. The capacities extracted are lower than those typically observed at much higher temperatures of 400° C. or more for the standard thermal-battery electrolytes (e.g., LiCl—KCl eutectic). In addition, the composition and processing of the separator material have not been optimized for the TMAIm electrolyte, which would affect the overall cell impedance.

The initial voltage transient at the start of discharge is a result of insufficient lithiation (from the lithium oxide present) during heat-up of the cell after placing the cell between the platens. From previous experience with this phenomenon, it is felt that fusion of the cathode under argon will alleviate this undesirable trait.

For a second set of tests, tetraethylammonium bis(trifluoromethylsulfonyl)imide salt ((CH₂CH₃)₄N(CF₃SO₂)₂N) (“TEAIm”) was prepared as follows. A solution of 27.7 g of tetraethylammonium chloride hydrate in 200 mL of water was added to a solution of 43.1 g of lithium bis(trifluoromethylsulfonyl)imide in 200 mL water with stirring followed by addition of 100 mL water. The mixture was stirred 0.5 h, cooled to 3° C. and filtered. The precipitate was washed 7 times with 100 mL of cold water. The product was air dried by pulling air though the material while still in the filter for about an hour and then dried 6 hours at 150° C. under vacuum to give 56 g (91% isolated yield) of tetraethylammonium bis(trifluoromethylsulfonyl)imide, having a melting point of 104-105° C.

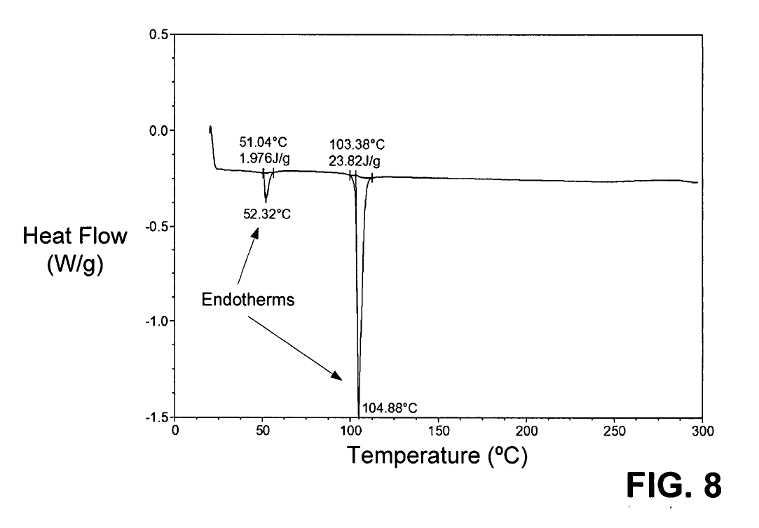

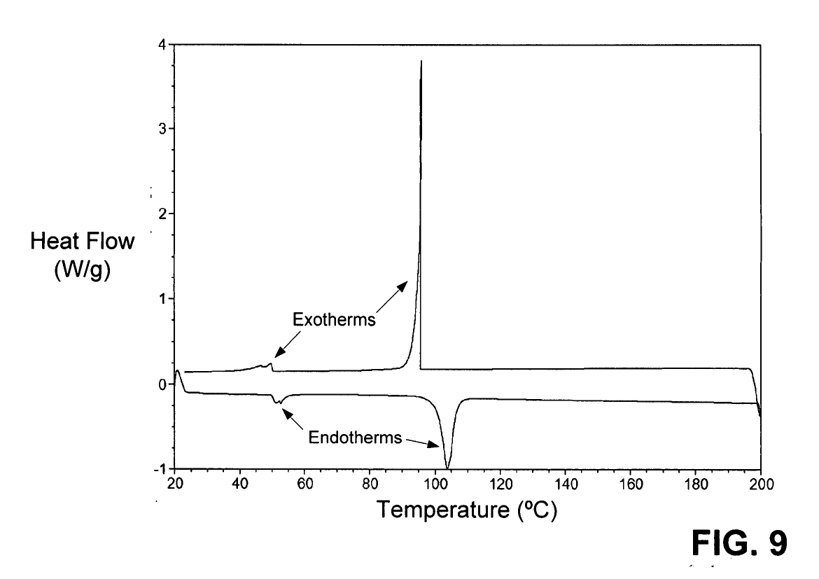

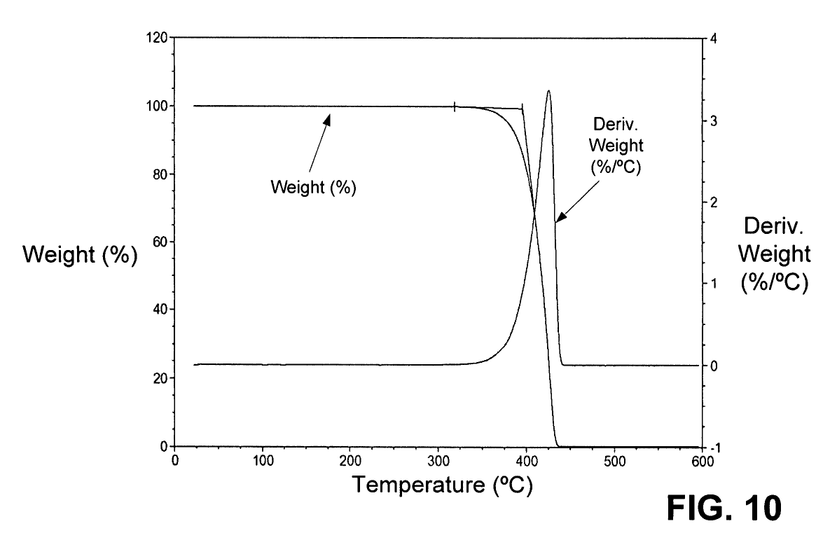

The thermal stability of TEAIm alone was tested as follows. A sample of TEAIm which was dried for an additional 1 h under vacuum at 150° C. and then analyzed by DSC and TGA. As shown in FIG. 8, the DSC indicated two endotherms at 52° C. and 105° C. which were still present when the sample was rescanned. As shown in FIG. 9, a cyclic DSC was conducted and exotherms were observed at about 95° C. and 49° C. on cooling. The exotherms on cooling correspond to heat liberation upon the freezing of the electrolyte (not a reaction with the anode material). Note that the peaks at 49° C. and 52° C. became misshapen after multiple scans. The material had a sharp melting point at 104.0-104.6° C. Proton Nuclear Magnetic Resonance also did not reveal any impurities. The above data tend to imply that the endotherm at 52° C. may be due to a solid-solid or structural phase change and is not believed to be due to an impurity. As shown in FIG. 10, TGA indicated that TEAIm has thermal stability to about 325° C., with a thermal decomposition temperature of about 350° C.

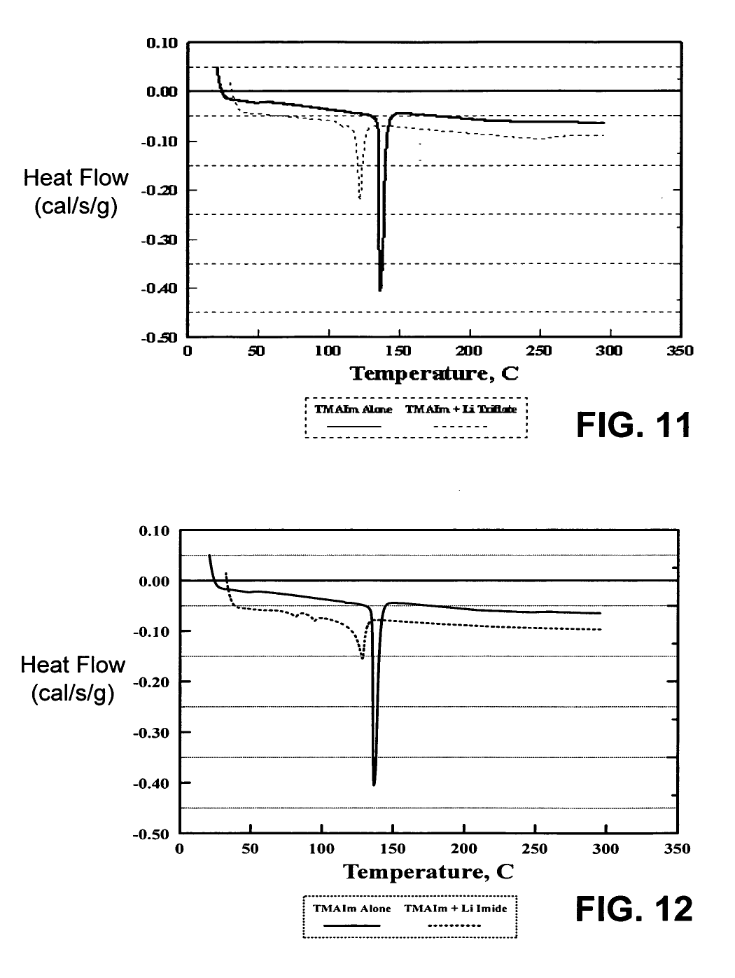

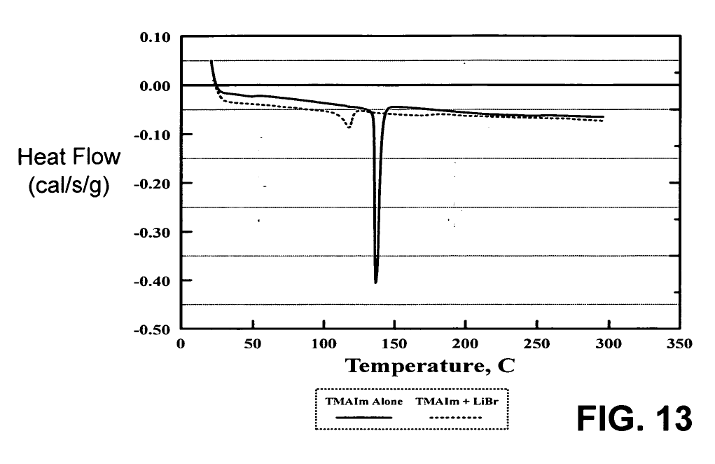

In addition, tests were performed by DSC to sample the thermal stability and the reduction in melting point if tetraalkylammonium salts are mixed with other compatible salts. FIG. 11 shows the results for TMAIm alone and mixed with lithium trifluoromethane sulfonate; FIG. 12 shows the results for TMAIm alone and mixed with lithium bis(trifluoromethylsulfonyl) imide; and FIG. 13 shows the results for TMAIm alone and mixed with lithium bromide. The molar ratios of materials in these tests were not optimized and better results may be possible with these same materials. Even so, these results illustrate a reduction of approximately 20° C. in the melting point below that of TMAIm. As tested, the mixtures appear thermally stable to at least 300° C., as evidenced by the absence of exotherms. A melting point-composition analysis has not yet been performed on these mixtures, and it is not yet known whether the combinations illustrated in FIGS. 11-13 are true eutectics; among other things, a melting-point composition analysis would reveal an optimal mixture of materials to minimize the melting-point.

In addition to these two component mixtures, it is also conceived that three-and-more component mixtures may yield improved melting point and operational characteristics. For example, tests are contemplated with combinations of blends of different tetraalkylammonium salts mixed with one or more of these other compatible salts; and a tetraalkylammonium salt mixed with two or more of these other compatible salts.

In conclusion, the single-cell test results indicate that the use of tetraalkylammonium salts is a viable approach towards the realization of a medium-temperature thermal battery that produces a stable voltage across the 200° to 300° C. temperature range (e.g., guided ordinance), and are at least operable across the 100° C. to 400° C. temperature range (e.g. boreholes).

Specific examples of the invention are illustrated and/or described herein. However, it will be appreciated that modifications and variations of the invention are covered by the above teachings and within the purview of the appended claims without departing from the spirit and scope of the invention.

What is claimed is:

1. An electrochemical cell comprising:
a cathode and an anode; and
an electrolyte having a melting point between 75° C. and 200° C., a thermal decomposition temperature above 300° C., and consisting essentially of at least one organic salt,
wherein the electrolyte is ionically conductive at temperatures from the melting point to at least the thermal decomposition temperature, generating a voltage across the cathode and the anode, and
wherein the electrolyte is ionically non-conductive at temperatures below the melting point.

2. The electrochemical cell according to claim 1, wherein said at least one organic salt includes a tetraalkylammonium cation.

3. The electrochemical cell according to claim 2, wherein said tetraalkylammonium cation is selected from the group consisting of a tetramethylammonium cation and a tetraethylammonium cation.

4. The electrochemical cell according to claim 2, wherein the tetraalkylammonium cation contains more than one alkyl species.

5. The electrochemical cell according to claim 4, wherein said more than one alkyl species includes both an ethyl and a methyl.

6. The electrochemical cell according to claim 2, wherein said tetraalkylammonium cation is a dialkylpyrrolidium cation.

7. The electrochemical cell according to claim 2, wherein said at least one organic salt is a eutectic.

8. The electrochemical cell according to claim 2, wherein said at least one organic salt further comprises an imide-based anion.

9. The electrochemical cell according to claim 8, wherein the imide-based anion is selected from the group consisting of bis(trifluoromethylsulfonyl) imide, bis(perfluorinatedalkylsulfonyl) imide, and bis(trifluoromethyl)imide.

10. The electrochemical cell according to claim 2, wherein said at least one organic salt further comprises an anion selected from the group consisting of halides, alkylsulfonates, arylsulfonates, perfluorinatedalkylsulfonates, tetrafluoroborate, trifluoromethanesulfonate, dicyanamide, tris(trifluoromethylsulfonyl)methide, and bis(trifluoromethylsulfonyl)methane.

11. The electrochemical cell according to claim 2, the electrolyte further comprising lithium trifluoromethane sulfonate, lithium bromide, and/or a lithium imide.

12. The electrochemical cell according to claim 11, wherein the lithium imide is lithium bis(trifluoromethylsulfonyl)imide.

13. The electrochemical cell according to claim 2, the anode consists essentially of a first material selected from the group consisting of Li, Li(Al), Li (Si), Li(Mg), other lithium alloys, Mg, Mg alloys, Ca, Ca alloys, Na, Na alloys, K, and K alloys.

14. The electrochemical cell according to claim 13, wherein for temperatures at least up to and including 300° C., no exothermic chemical reactions occur between the electrolyte and the first material of said anode.

15. The electrochemical cell according to claim 13, further comprising an anode binder to immobilize the first material of the anode when in a liquid state, the anode binder comprising a transition metal.

16. The electrochemical cell according to claim 13, the cathode comprising a second material selected from the group consisting of FeS₂, CoS₂, CrO₂, LiCoO₂, NiS₂, MnO₂, LiMn₂O₄, Ag₂CrO₄, K₂Cr₂O₇, WO₃, PbCrO₄ and CaCrO₄.

17. The electrochemical cell according to claim 2, the cathode comprising a material selected from the group consisting of FeS₂, CoS₂, CrO₂, LiCoO₂, NiS₂, MnO₂, LiMn₂O₄, Ag₂CrO₄, K₂Cr₂O₇, WO₃, PbCrO₄ and CaCrO₄.

18. The electrochemical cell according to claim 2, further comprising an electrolyte binder to immobilize said at least one organic salt when molten, the electrolyte binder comprising a material selected from the group consisting of an oxide, a nitride, and an oxynitride.

19. The electrochemical cell according to claim 1, wherein the cell is flexible.

20. The electrochemical cell according to claim 1, further comprising a pyrotechnic.
